(19) United States
(12) Patent Application Publication
(10) Pub. No.: US 2025/0350170 A1
(43) Pub. Date: Nov. 13, 2025

(54) ELECTRIC MOTOR WINDING SPRAY TUBE RETENTION

(71) Applicant: Magna Powertrain of America, Inc., Troy, MI (US)

(72) Inventors: Lee McCay, Windsor (CA); Esteban Escobar, Monterrey (MX); Brendan Conneely, Madison Heights, MI (US); Ritchie Walsh, Royal Oak, MI (US); Suresh Raju, Ferndale, MI (US); Ivan Macias, Ramos Arizpe (MX)

(21) Appl. No.: 19/199,704

(22) Filed: May 6, 2025

Related U.S. Application Data
(60) Provisional application No. 63/644,748, filed on May 9, 2024.

(51) Int. Cl. H02K 9/193

(52) U.S. Cl. CPC H02K 9/193

(57) ABSTRACT

An electric motor assembly has a motor housing, a stator with end windings, and a rotor. A feed line for cooling fluid is formed in the motor housing and receives cooling fluid from a sump formed in the bottom of the housing cavity. A spray tube is connected to the feed line at an end face of the motor housing, and extends across the top of the end windings. A first spray tube end is secured to the housing via a connector, and a second end is secured to the housing via a tube locator disposed in a pocket of the housing. The tube locator fixes the orientation of the spray tube outlets toward the end windings. The connector may also provide the cooling fluid to a rotor supply tube, which feeds the cooling fluid into the rotor shaft cavity. All of the cooling fluid returns to the sump.

### CROSS-REFERENCE TO RELATED APPLICATIONS

This application claims the benefit of U.S. Provisional Patent Application No. 63/644,748, filed May 9, 2024, the entire content of which is hereby incorporated by reference in its entirety.

### FIELD

The present disclosure relates to a design and method to cool the windings of an electric machine installed into a housing utilizing a spray tube positioned above the end windings of the electric machine delivering a cooling medium to the end windings.

### BACKGROUND

This section provides background information related to the present disclosure which is not necessarily prior art. Electrification of motor vehicles continues to increase, particularly in applications where motor output power and power density are increasing, resulting in increased heat generation during continuous and peak operating condition. Electric machines, such as motors and generators, generate heat in their stator core and windings when in use. Cooling of the electric machine windings, in particular the end windings extending from the electric machine's stator, is required to operate optimally and to avoid damage to the components when operated. Various options exist to cool the end windings of the electric machine, including providing a spray ring positioned fully surrounding the end windings, as described in US20190006914, or including passages in the motor housing to deliver oil to the end windings, as shown in U.S. Ser. No. 10/690,124. Although these are acceptable solutions in some applications, in other arrangements such solutions are not possible due to the restrictive environment and lack of packaging space when the motor is assembled into the electric motor housing.

### SUMMARY

This section provides a general summary of the many aspects associated with the inventive concepts embodied in the teachings of the present disclosure and is not intended to be considered a complete listing of its full scope of protection nor all of its features and advantages.

It is beneficial to provide a solution which does not fully surround the end windings, as these arrangements are only required in the highest-powered motors. Further if a solution eliminates cross drilled holes within the motor housing, reduced overall packaging and reduction in machining costs may be achieved. An electric machine may also further be cooled by applying cooling medium to the internal portion of a hollow rotor. Because the end windings and the rotor shaft may be cooled by the same medium, it would be also advantageous to provide an arrangement where a single source of cooling medium is provided with a simplified assembly and which provides distribution of the cooling medium directly to the end windings and the rotor shaft.

It is an aspect of the present disclosure to provide cooling medium to a winding of an electric machine via a spray tube as a separate component from the motor housing, positioned above and perpendicular to an end winding of the electric machine.

The spray tube is held in position on a first end via engagement to the motor housing and on a second end inserted into a pocket formed into the split line face of the motor housing. An optional rotor shaft cooling tube may also be mechanically engaged and in fluidic communication with the spray tube, either in a direct connection or via a connection piece, to deliver the cooling medium to the inner surface of the rotor shaft and position the spray tube in a second arrangement

It is a related aspect of the present disclosure for the spray tube to be installed into and held in position by the motor housing on a first end and a second end.

It is a related aspect of the present disclosure for the spray tube to be supported on the first end via insertion into a sealing and receiving bore of the motor housing and on the second end via a pocket in the motor housing open to the split line face of the motor housing.

It is a related aspect of the present disclosure for the spray tube to be captured between a motor housing and a motor cover to maintain location.

It is an aspect of the present disclosure to provide cooling medium to a winding of an electric machine via a spray tube as a separate component from the motor housing positioned above and perpendicular to an end winding of the electric machine and to further cool the interior of the rotor of the electric machine via a rotor cooling tube which is mechanically engaged and in fluidic communication with the spray tube directly or via a separate connector piece.

It is a related aspect of the present disclosure to locate and secure the first end of the spray tube or a connection piece into the motor housing via the rotor cooling tube's attachment to a surrounding structural component.

These and other features and advantages of the present disclosure will become more readily appreciated when considered in connection with the following detailed description and the drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a view of the spray tube and rotor cooling tube utilized with an electric machine.

FIG. 2 is a view of the spray tube and rotor cooling tube from above the electric machine end winding.

FIG. 3 is a view of the spray tube and rotor cooling tube from the open end of the motor housing.

### DETAILED DESCRIPTION

The present disclosure is related to a design of a multipart cooling medium distribution device and a method to use the cooling medium distribution device to provide cooling to the windings and rotor of the electric machine. The present disclosure is presented as being utilized in an electrically driven axle for use in a motor vehicle, but other applications may also be applicable.

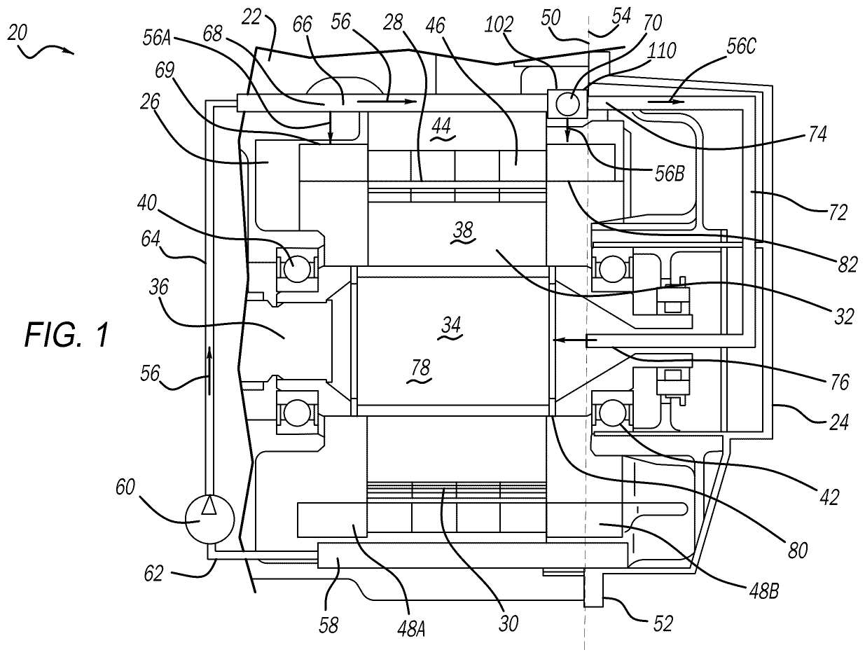

A cross section of an electric motor assembly 20 is shown in FIG. 1. Electric motor assembly 20 includes a motor housing 22 and a motor cover housing 24 creating a cavity 26 surrounding electric machine 28. Electric machine 28 includes a stator 30 assembly fixed to motor housing 22 and a rotor assembly 32 surrounded by stator 30. Rotor assembly 32 is free to rotate relative to the stator assembly 30. Rotor assembly 32 includes a hollow rotor shaft 34, a rotor output shaft 36, and a rotor body 38, all attached and fixed to each other. The rotor output shaft 36 provides the power output of electric machine 28, when energized, to a mechanically connected load, such as a gearbox or transmission in an electric drive axle application. Rotor shaft 34 is supported for rotation relative to motor housing 22 via a first rotor bearing 40 and a second rotor bearing 42 installed into to cover 24.

The stator assembly 30 of electric machine 28 includes a stator body 44 with a multitude of windings 46 wound into slots within the stator body 44, as known. Windings 46 are laid and wound within the stator body 44 slots, resulting in a winding head or end winding 48 extending from each the end of stator body 44 in both directions along the axis of rotation of rotor assembly 32. A first end winding 48A extends from the stator body 44 in the direction of first rotor bearing 40 and is fully surrounded by motor housing 22. Second end winding 48B extends from stator body 44 in a second opposite direction, where a portion of the second end winding 48B extends towards end face 50 of motor housing 22. End face 50 of motor housing 22 is in contact with a cover end face 52 of motor cover 24. A housing split line 54 is defined where the two end faces 50 and 52 meet and connect together. Cover 24 is held to housing 22 via fasteners (not shown) and create a sealed volume or cavity 26 between them. Cover 24 and motor housing 22 are provided for illustrative purposes and may also be made of multipart housings performing the same function and general arrangement as shown.

During operation of electric machine 28, heat is generated within stator assembly 30 due to current passing through windings 46 and within the rotor body 38. Therefore it is beneficial to cool the windings 46 and the rotor body 38 to maintain optimum operating conditions. Within cavity 26, a non-electrically conductive fluid, for example oil, automatic transmission fluid, or gear lubricant, may be provided and shared with a mating gearbox or transmission. This fluid may be used to lubricate and cool the gearset, supporting bearing systems, and electrical components, including portions of the electric machine 28. A quantity of this cooling medium 56 is captured within a sump 58 located in the lower portion of cavity 26. Cooling medium 56 is delivered under pressure with the usage of pump 60. The electrically or mechanically driven pump 60 may be provided within or mounted onto motor housing 22, pulling cooling medium 56 from sump 58 via a pump feed line 62. Once pressurized, cooling medium 56 is delivered to electric machine 28 via supply line 64.

In one aspect of the disclosure, sump line 62 and feed line 64 are passages provided within motor housing 22, but other solutions may be utilized. The cooling medium 56 distributed by pump 60 is considered a closed circuit, where cooling medium 56 is distributed for the purposes of cooling electrical machine 28, possibly further cooled by an optional heat exchanger, and eventually returned to sump 58 for reuse without a loss of volume. The pressurized cooling medium 56 is provided into motor housing 22 in a manner where a feed line 66 is provided via a cross drilling or a cast passage through motor housing 22 in line with the rotational axis of rotor assembly 32 and located above stator assembly 30. Feed line 66 is used to first provide cooling medium 56 to first end winding 48A conventionally, including passages drilled perpendicularly and vertical to feed line 66 to create a plurality of nozzles 68 to distribute a portion of cooling medium 56A to top portion 69 of first end winding 48A.

As will be further described using later figures, the remaining cooling medium 56 is conveyed via feed line 66 and utilized to supply cooling medium 56B to spray tube 70, which is positioned above second end winding 48B, and optionally further provides the remaining cooling medium 56C to rotor cooling tube 72. In one aspect, rotor cooling tube 72 has a first inlet end 74 engaged mechanically and providing a leak free fluidic communication with spray tube 70. Rotor cooling tube 72 may extend internal to cover 24 and within cavity 26 towards rotor shaft 34, where second outlet end 76 extends into the inner hollow portion 78 of rotor shaft 34 without contact, distributing cooling medium 56C to the internal portion of rotor shaft 34. This allows cooling medium 56C to distribute heat away from rotor body 38 via conduction with rotor shaft 34. Cooling medium 56C exits hollow portion 78 via openings 80 which may also be used to spray the bottom portion 82 of end windings 48A and 48B.

Thus, as cooling medium 56A exits the nozzles 68 above the first end winding 48A, remaining cooling medium 56 is distributed to spray tube 70 positioned above second end winding 48B and optionally further to the hollow portion 78 of rotor shaft 34, the cooling medium 56B and 56C will be dispensed, eventually flowing back into sump 58. Cooling medium 56 will be returned to sump 58 and again supplied to pump 60 via pump feed line 62.

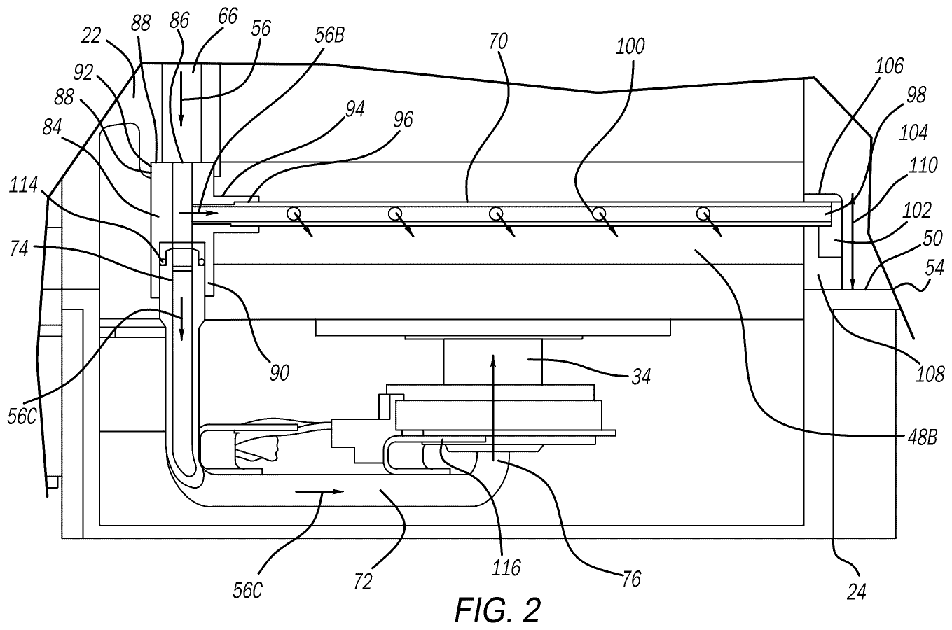

Referring to FIG. 2, a sectional view taken through the center of spray tube 70 and looking downward to electrical motor assembly 20 in the region of split line 54 between housing 22 and cover 24 is provided. For reference, the rear of the page of FIG. 1 is at the right side of FIG. 2, the front of the page of FIG. 1 is at the left side, and the right side of FIG. 1 is at the bottom of FIG. 2.

Feed line 66, passing through housing 22, is seen providing cooling medium 56 towards spray tube 70. Spray tube 70 is positioned above and perpendicularly across second end winding 48B. The embodiment shown depicts three separate components to further distribute cooling medium 56 from feed line 66. These include a spray tube 70, a connector 84, and rotor supply tube 72. Depending on usage, these three components may be provided as separate components, as shown, or may be integrated together in some manner to form a reduced number of components with the same functionality. For instance, spray tube 70 and connector 84 may be integrated into one component. Alternatively, rotor supply tube 72 may be integrated into connector 84 while spray tube 70 is provided as a separate component. The benefit of utilizing three different components is that they may be shared with other applications, and it may result in simplified components. These components will be described with their functionality and fluid connectivity to each other, and it should be understood these components may be integrated or provided separately depending on application, cost, and ease of assembly with the inventive features maintained. Put another way, referred to the spray tube or the rotor supply tube may also be a reference to that corresponding portion of an integrated or unitary tube arrangement.

FIG. 2 shows an arrangement utilizing both a spray tube 70 and a rotor supply tube 72, although a first alternative is also contemplated where spray tube 70 is utilized without rotor supply tube 72, because not all applications may require rotor shaft 34 cooling. For illustration and interpretation purposes of the first alternative, the illustrated end of the T-shape of connector 84 may be considered a closed end, or the housing split line may be considered a closed surface of cover 24 against which the T-shaped connector contacts.

In this alternative arrangement with no rotor supply tube 72, spray tube 70 may include the features of connector 84 integrated into spray tube 70 or utilize a separate connector 84 as shown. The features of connector 84 in a configuration where rotor supply tube 72 is not utilized may include a connector inlet end 86 which may include an outer diameter 88 and a second end 90 which may either be closed off and sealed or open but sealed with resulting contact to cover 24 after assembly. Because no rotor supply tube 72 is provided in this embodiment, no fluidic connection is made at second end 90. Cover 34 may be provided in a manner to further contact and support the second end 90 of connector 84 if required. Outer diameter 88 is utilized to be inserted into a bore 92 in motor housing 22 to locate and seal the first end 86 of connector 84 to feed line 66. The fit between outer diameter 88 and bore 92 is preferably a tight fit. Connector 84 may be L shaped, or T shaped in this arrangement, including a fluidic connection 94 located between and perpendicular to inlet first end 86 and second end 90 to spray tube 70. Spray tube 70 includes a first inlet end 96 nearest to and receiving the supply of cooling medium 56B from feed line 66 via connection 94 and a second sealed end 98 furthest away from feed line 66.

Spray tube 70 includes a plurality of nozzles 100 which will allow cooling medium 56B to exit and spray onto second end winding 48B from above. Such an arrangement with no rotor shaft cooling will result in cooling medium 56 supplied to feed line 66 to be directed fully into spray tube 70, distributing cooling medium 56B without leakage from feed line 66, through connector 84 and into spray tube 70. Spray tube 70 is supported on inlet end 96 via connector 84 or features thereof and on its sealed end 98 by motor housing 22 in a pocket 102. The pocket 102 is provided in motor housing 22 to receive second sealed end 98 of spray tube 70. The pocket 102 is provided a depth 104 with a closed end 106 formed into motor housing 22 and an open end 108 is provided on housing end face 50 at split line 54. This allows spray tube 70 to be easy installed into housing 22 by positioning the sealed end 98 of spray tube 70 into the pocket 102. The installation of spray tube 70 may occur prior to assembly of cover 24 to housing 22. Spray tube 70 is supported on its first inlet end 96 by connector 84, or features integrated into spray tube 70, via its insertion into bore 92 of housing 22 and on the second sealed end 98 via insertion fully into pocket 102. The second end 98 may include a locating feature 110, shown as a rectangular form similar to pocket 102 dimensionally in the example provided. The purpose of this locating feature 110 at the second sealed end 98 of spray tube 70 is to ensure orientation of nozzles 108 relative to the top surface 69 of second end winding 48B to ensure cooling medium 56B is sprayed in the correct downward direction. Locating feature 110 may also be optionally contacted by features of the cover 24 that may extend into pocket 102 when cover 24 is fastened to motor housing 22. Such a feature may contact or closely be positioned to locating feature 110 to further secure the second sealed end 98 of spray tube 70 into pocket 102 at full depth 104. Other pocket 102 designs in combination with locating feature 110 may be utilized to provide a similar aligned installation.

In the embodiment explicitly shown in FIG. 2, the arrangement being where a rotor supply tube 72 is included, will now be described. The features of spray tube 70 as previously describe are maintained, with the connector 84 being open to distribute cooling medium 56B into spray tube 70 via fluidic connection 94 and also to further distribute cooling medium 56C to rotor supply tube 72 via second end 90. The second end 90 of connector 84 is not sealed by itself of closed off by cover 24, instead connector 84 will include an open bore 112 to receive a first open inlet end 74 of rotor supply tube 72 as shown in FIG. 2. Connector 84 in this embodiment is T shaped, with an inlet 86, a first connection or outlet 94, and a second outlet at end 90. A sealed connection where first rotor supply tube end 74 is inserted into connector bore 112 may be provided utilizing an o-ring 114. Rotor supply tube 72 is constructed in a manner to direct cooling medium 56C exiting feed line 66 to the hollow portion 78 of rotor shaft 34. The second open outlet end 76 is inserted into hollow cavity 78 of rotor shaft 34 to deliver cooling medium 56C to cool the rotor shaft 34 and surrounding components of electric machine 24. Rotor supply tube 72 may include mounting flanges 116 connected to motor housing 22 or cover 24 or other structural component, assisting in locating of rotor supply tube 72 to the center of rotor shaft 34 and cooling medium 56C supplied by feed line 66. Fixing rotor supply tube 72 in position may be utilized to further locate and fix connector 84 and/or first end 96 of spray tube 70 into motor housing 22. This will provide support and provide a force onto connector 84 and/or first end 96 of spray tube 70 to ensure no leakage to feed line 66 and proper locating of these components relative to the second end winding 48B.

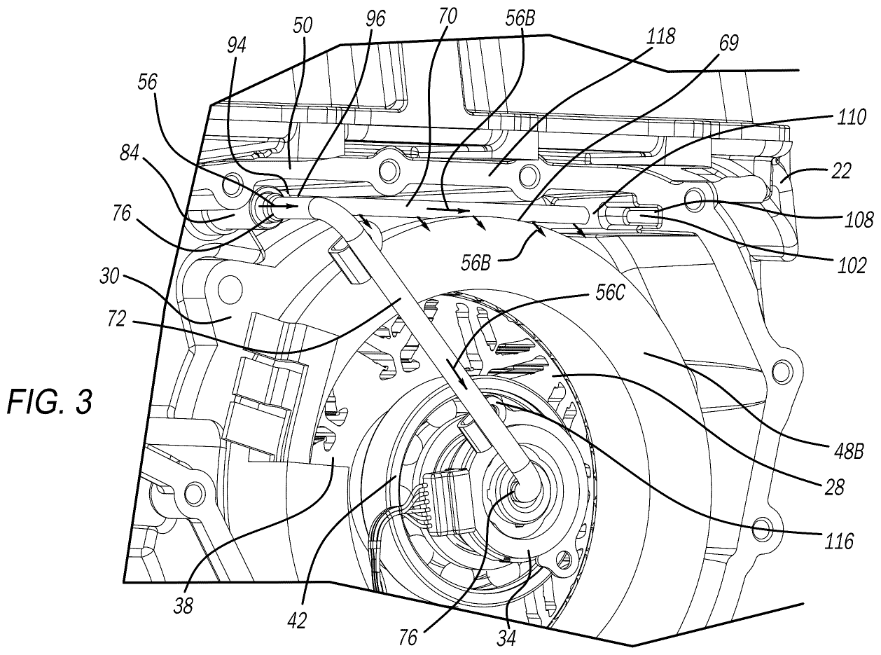

Referring now to FIG. 3, the arrangement of spray tube 70, rotor cooling supply tube 76 and second end winding 48B are seen with cover 24 removed or prior to installation for clarity. The arrangement of connector 84 inserted into motor housing 22 is seen, providing further mechanical and fluidic connection to the first inlet end of spray tube 70 at connection 94 and the first inlet end 76 of rotor supply tube 72 at connector end 90. Spray tube 70 can be seen recessed relative to the mounting flange 118. Rotor supply tube 72 with integral mounting flanges 116 is shown. Mounting flanges 116 are fastened to a surrounding structural component (not shown in this view) to secure rotor supply tube 72 as previously described. Spray tube 70 is shown positioned just above end winding 48B top surface 69. Note in this arrangement, there is very little space between the winding top surface 69 and upper flange portion 118 of housing end face 50. It would be difficult to provide a passage within motor housing 22 to provide cooling medium 56B while positioned directly above the end winding 48B. The usage of spray tube 70, where a thin-walled member of a reduced overall diameter, rather than a passage machined in a housing, is accordingly successfully used in this reduced packaging environment. The utilization of a spray ring surrounding the end winding 48B would also be complex in an arrangement with a serviceable electric machine 22 where stator assembly 30 is required to be removed and replaced from motor housing 22. The usage of a spray tube 70, and rotor supply tube 72, as described, may be removed and reinstalled after stator assembly 30 replacement as needed. Therefore, this arrangement is beneficial in providing a very cost-effective and serviceable solution to deliver cooling medium to a motor end winding in both variants described and also may provide rotor shaft cooling in the second variant described.

FIG. 3 further illustrates the arrangement of the tube locator 110 in the pocket 102 and the pocket open end 108 allowing for easy insertion. The outlets of the spray tube 70 are accordingly controllable pointed in the downward direction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. An electric motor assembly comprising:
a motor housing;
an electric machine disposed in the motor housing and including a stator assembly with at least one end winding;
a fluid circuit including a sump at a bottom of the motor housing and a fluid feed line extending within the motor housing;
a spray tube in fluid communication with the fluid feed line, wherein the spray tube is positioned above the at least one end winding, the spray tube receiving a cooling medium from the fluid feed line within said motor housing, wherein the spray tube includes at least on outlet directed toward the at least one end winding that sprays cooling medium onto the at least one end winding.

2. The electric motor assembly of claim 1, wherein the spray tube has first and second ends, wherein the spray is supported by the motor housing on the first and second ends.

3. The electric motor assembly of claim 2, wherein the spray tube is supported on the first end via a mechanical and fluidic connection to the motor housing, and the second end is received within a pocket of the motor housing.

4. The electric motor assembly of claim 3, wherein the second end of the spray tube is closed and includes a tube locator fixed to the second end, wherein the tube locator is fitted within the pocket of the motor housing and fixes an orientation of the tube such that the at least one outlet of the spray tube is directed toward the at least one end winding.

5. The electric motor assembly of claim 1, wherein the spray tube is recessed relative to a mounting flange face of the motor housing, wherein the mounting flange face is configured to mate with a housing cover.

6. The electric motor assembly of claim 1, wherein a connector is provided between the first end of the spray tube and the motor housing, wherein the connector has an inlet in communication with the feed line, wherein the connector provides a mechanical and fluidic connection between the spray tube and feed line of the motor housing.

7. The electric motor assembly of claim 6, wherein the feed line is in the form of a through-bore extending through a body of the motor housing, wherein the bore is cross-drilled or casted.

8. The electric motor assembly of claim 6, wherein the connector inlet has an outer diameter that is received in a recess formed in the housing at an outlet end of the feed line.

9. The electric motor assembly of claim 6, wherein the spray tube and connector are separate pieces.

10. The electric motor assembly of claim 6, wherein the spray tube is attached to a first connector outlet of the connector.

11. The electric motor assembly of claim 6, wherein the connector includes a second connector outlet that is mechanically and fluidically connected to a rotor supply tube, wherein cooling fluid from the feed line is provided to the spray tube through the first connector outlet and also to the rotor supply tube through the second connector outlet.

12. The electric motor assembly of claim 11, wherein the rotor supply tube has a first end and second end, wherein the first end is attached to the second connector outlet, and the second end provides cooling fluid to an interior of the rotor shaft.

13. The electric motor assembly of claim 12, wherein the rotor shaft includes openings providing fluid communication from the rotor cavity to the interior of the housing.

14. The electric motor assembly of claim 13, wherein the cooling circuit is a closed loop, such that all of the cooling fluid provided to the feed line reaches the sump and is fed back to the feed line.

15. The electric motor assembly of claim 12, wherein the rotor supply tube is fastened to a surrounding structural component to further support and hold the connector to the motor housing.

16. The electric motor assembly of claim 15, wherein the surrounding structural component is a motor cover housing attached to the motor housing.

17. The electric motor assembly of claim 1, wherein the at least one end winding includes first end windings and second end windings, wherein the first end windings are disposed at a first axial end of the electric machine and the second end windings are disposed at a second end of the electric machine and at least partially extending toward an end face of the motor housing, wherein the spray tube is disposed above the second end windings at the end face.

18. The electric motor assembly of claim 17, wherein a nozzle extends from the first feed line toward the top of the first end windings.

19. The electric motor assembly of claim 18, wherein cooling fluid is pressurized and fed into the feed line via a supply line from a pump that draws the cooling fluid from the sump, wherein a first portion of the cooling fluid is provided to the first end windings, wherein a second portion of the cooling fluid is provided via the feed line to the spray tube and the second end windings, wherein both the first portion and the second portion return to the sump after cooling the end windings.

20. The electric motor assembly of claim 19, wherein a third portion of the fluid is provided via the feed line to rotor supply tube in fluid communication with a rotor cavity of the rotor shaft, wherein the third portion exits the rotor cavity via openings formed in the rotor shaft and returns to the sump after cooling the rotor.
